(19) United States
(12) Patent Application Publication
(10) Pub. No.: US 2025/0153943 A1
(43) Pub. Date: May 15, 2025

(54) MODULAR STORAGE SYSTEM, METHOD FOR CONSTRUCTING A STORAGE SYSTEM, AND STORAGE METHOD

(71) Applicant: Noyes Robotics GmbH, München (DE)

(72) Inventors: Marco PRÜGLMEIER, München (DE); Christopher MAYERSHOFER, Odelzhausen (DE)

(21) Appl. No.: 18/725,046

(22) PCT Filed: Dec. 29, 2022
(86) PCT No.: PCT/IB2022/062875

§ 371 Date: Jun. 27, 2024

(30) Foreign Application Priority Data
Dec. 30, 2021 (DE) 10 2021 006 415.1

(51) Int. Cl. B65G 1/137

(52) U.S. Cl. CPC B65G 1/137; B65G 2201/0235

(57) ABSTRACT

A modular storage system with at least two horizontal robot levels, wherein the robot levels are formed by at least three baseplates, at least eight vertical supports which are perpendicular to the robot levels and support the robot levels, at least one robot on each robot level, which robot can move on the robot level, and, per robot level, at least two container carriers which can be moved by the robot.

The present invention relates to a modular storage system equipped with robots, and also to a method for constructing such a storage facility and to a method for storing goods in such a storage facility.

Storage systems are used for a variety of different applications.

Storage systems, as described in U.S. Pat. No. 9,701,475 B2, can move motor vehicles to storage locations and store and retrieve them. U.S. Pat. No. 9,701,475 B2 describes a modular, semi-automatic or automatic parking system that can also be installed in a location that has an irregular shape. The modular design should make this possible without the need for a special construction. The individual cells are individually equipped with cell transport mechanisms that interact with a transport mechanism of a feeder system.

Automated storage and retrieval systems, as described in US 1 0246 255 B2, are often used in warehouses or logistics or fulfillment centers to store and retrieve items. Such automated storage and retrieval systems often include computer-controlled retrieval machines that move along predetermined paths to retrieve storage containers (or other storage units) and transfer the container to an operator or other automated system. Automation can help to increase packing density in the storage system through tight three-dimensional placement and to reduce operating costs.

Three-dimensional storage systems with a high packing density are also known from WO 2017 037 095 A1, and the associated problems of removing goods from such storage systems are discussed. DE 102018105614 A1 also shows a block storage facility with a high packing density. In an at least two-dimensional array, storage locations are arranged without aisles in the X and Y directions for storing at least one load carrier in each case. A driverless transport system can drive under the load carrier for storage and/or retrieval, lift it and move it in the X and/or Y direction. The driverless transport system can be moved in at least the X and Y directions.

Automatic picking machines are known from the pharmacy sector and the pharmaceutical wholesale trade, as described in EP 0 369 060 A1, for example.

A standardized, modular storage unit is known from CN 111942790 A, in which several storage units stacked on top of each other can form a stereo storage facility with high space utilization, as well as a three-dimensional storage facility with a large number of storage layers and a large number of displacement layers, wherein the overall frame of the three-dimensional storage facility can be formed from a combination of several individual, interconnected storage units.

Many of the known storage systems are individually designed and installed in halls built and intended for the storage systems. Special solutions, such as those described in US '475, are intended for special applications, such as the storage of motor vehicles, in which the space for the storage system is limited, e.g., in dense inner city areas, and are complex and heavy in their design. Automated order picking systems are only suitable for rather small and suitably packaged goods and are only scalable to a limited extent.

Against this background, one object of the present invention is to provide a storage system that combines flexibility in design with a cost-effective modular structure.

A further object of embodiments of the present invention is to provide a storage system that can be installed in existing building structures. In particular, a good use of space in the case of more complex space geometries with columns, beams, corners and projections should be made possible.

A further object of embodiments of the present invention is to provide a storage system suitable for use in existing building structures that were not built for heavy loads. In inner city locations, residential or office premises are used as storage facilities. Such premises are only intended for limited static loads. In order to fit a storage system into such a building, the storage system must be as light as possible.

A further object of embodiments of the present invention is to provide a storage system in urban centers with high costs for space, which supports quick commerce—the fast delivery of goods in a short time. Such a storage system should be able to be integrated cost-effectively into existing building structures in inner city areas, and different goods of different sizes, which can be transported, e.g., on foot, by bicycles, with delivery robots or with drones, should be able to be efficiently stored and retrieved in the storage system.

A further object of embodiments of the present invention is to provide a system for a storage system that can be flexibly assembled and dismantled, which can be assembled at one location, dismantled again after a utilization phase and reassembled at another location, even with a different spatial structure.

A further object of embodiments of the present invention is that no or little maintenance or expert knowledge is required at the location of the storage facility to operate the storage facility.

A modular storage system is therefore proposed in which robots move on at least two horizontal robot levels. The robot levels are realized with baseplates. Vertical supports, which are perpendicular to the horizontal robot levels, hold the robot levels at the respective height.

According to one embodiment, the baseplates are substantially rectangular. Substantially rectangular can be a rectangle or, for example, a rectangle that has recesses at the four corners and/or the corners of which are rounded. The baseplates can be adapted to the vertical supports by means of recesses.

The baseplates are between 300 mm×300 mm and 1000 mm×1500 mm in size for different areas of application of the storage system, e.g., in the quick-commerce sector.

According to one embodiment, the baseplates have a size of between 600 mm×400 mm and approximately 800×600 mm. Plates of this size can be easily transported and easily installed even by just one person.

According to one embodiment, baseplates in the storage system have a load capacity of at least 40 kg or at least 60 kg.

According to one embodiment, baseplates are made of metal, e.g., 4 to 8 mm thick aluminum sheets or steel sheets.

According to one embodiment, baseplates are made of wood or wood-based material. For example, baseplates are made of, in particular coated, MDF board, plywood or multiplex board. According to one embodiment, the thickness of the wooden or wood-based baseplates is between 15 and 30 mm. Wood and wood-based materials can provide advantages in terms of the damping of sound generated in the storage system.

According to one embodiment, the baseplates are made of plastic or composite materials. High-pressure laminates or plastic-metal composites can also be used.

The modular storage system has at least two robot levels.

According to one embodiment, the storage system has between three and ten robot levels.

According to one embodiment, the distances between the robot levels are between 300 and 1000 mm, in particular the distances between the robot levels are between 350 and 700 mm.

There is at least one robot on each robot level that can move on the robot level. Depending on the size of the storage system and the frequency with which goods are handled in the storage system, several robots can also be used on each robot level. According to one embodiment, the storage system has two or three robots on each robot level.

From two robots upwards, there is redundancy on each robot level of the storage system. If one robot fails, another robot can continue to operate the storage system.

According to one embodiment, a robot can also move another robot. A defective robot can thus be moved to a convenient position in the storage system.

According to one embodiment, the robots weigh less than 20 kg, in particular less than 15 kg.

The modular storage system has at least three baseplates on one robot level and at least eight vertical supports that are perpendicular to the robot levels and support the robot levels. The storage system can be extended in the horizontal plane by adding further baseplates and further vertical supports.

According to one embodiment, the modular storage system has between 50 and 400 baseplates on one robot level and between 64 and 450 vertical supports.

There are at least two container carriers on each robot level of the storage system that can be moved by the robot. Depending on the size of the storage system and the frequency with which goods are handled in the storage system, more container carriers can be used.

According to one embodiment, the base area of the container supports is between half the base area of the baseplate and the area of the baseplate, wherein the size and shape of the container supports is selected so that the container supports can be moved through between the vertical supports.

According to one embodiment, there is a maximum of one container carrier on or above a baseplate in the storage system. In this embodiment, the number of container carriers must be less than the number of baseplates so that the container carriers can be moved around in the storage system.

According to one embodiment, the container carriers are made of plastic, e.g., by injection molding.

According to one embodiment, the vertical supports comprise a plurality of pillars connected to each other in a direction perpendicular to the robot levels. According to one embodiment, the pillars are inserted into one another and/or screwed together.

According to one embodiment, the height of the pillars corresponds to the distance between the robot levels.

The vertical supports and pillars can be solid or hollow profiles. For example, square tubes can be used, the corners of which can also be rounded. The profile can be installed rotated by 90° along its longitudinal axis and, in one embodiment, the vertical supports and pillars have a substantially square cross section.

According to one embodiment, the storage system can be extended in height by adding further pillars and inserting one or more further robot levels with baseplates.

According to one embodiment, two pillars of a vertical support are each screwed together from all four sides with one angle profile each. Four vertical supports are connected by a baseplate on each robot level, wherein the baseplate is screwed to angle profiles that are screwed to the four vertical supports.

According to one embodiment of the storage system, the, in particular substantially rectangular, baseplates have lines in the longitudinal and/or transverse direction of the baseplates for guiding the robots through the storage system.

According to one embodiment of the storage system, the substantially rectangular baseplates have lines along the central axes of the baseplates to guide the robots through the storage system.

According to one embodiment of the storage system, the baseplates, in particular the substantially rectangular ones, have markings for positioning and in particular for centering the robots on a baseplate.

According to one embodiment, the robots have optical sensors for detecting the lines and/or the markings, in particular infrared line arrays.

According to one embodiment of the storage system, the baseplates have RFID tags for determining the absolute position and orientation of a robot in the storage system.

According to one embodiment, the lines and markings for positioning can be colored, milled or glued onto the baseplates.

According to one embodiment of the storage system, the baseplates have RFID tags, in particular the substantially rectangular baseplates have four RFID tags, for determining the absolute position and orientation of a robot in the storage system, wherein the four RFID tags are mounted on a circle around the center of the baseplate, each offset by 90°.

According to one embodiment of the storage system, the container carriers have feet that are higher than the height of the robots. The container carriers with the feet and the robots are shaped in such a way that robots can drive under the container carriers and turn under the container carriers. This can be achieved by making each cross section of the robot perpendicular to the robot level smaller than each cross section between the feet of the container carrier perpendicular to the robot level. The term “feet” here includes various types of supports with which the container carrier can be placed on the baseplates of the robot level so that the container carrier can be driven under by the robots and is stable on the baseplates of the robot level even without robots under the container carrier.

The robots can have lifting devices with which the robots can lift a container carrier with containers and goods and move it in the robot level.

By combining the lifting device of the robots with the feet of the container carriers, the baseplates of the robot level can simultaneously take the load of the container carriers and there is no need for a further level or devices to take the load of the container carriers on this further level, e.g., further plates, brackets or rails.

The robots and in particular the lifting device of the robots must be designed in such a way that it is able to lift and move the container carrier, the container and any goods in the container.

According to one embodiment of the storage system, the robots have at least one omni wheel and/or a mecanum wheel. In the case of omni wheels, the running surface of the wheel consists of rollers of which the axes of rotation are at right angles to the axis of rotation of the main wheel. This allows the wheel to be moved in an axial direction with little friction. The mecanum wheel is a wheel that allows a vehicle to perform omnidirectional maneuvers without being equipped with mechanical steering. In contrast to the omni wheel, the rollers of the mecanum wheel are at an angle to the main axis.

In particular, the robots have two driven wheels and two omni wheels. The driven wheels can be driven independently of each other, e.g., also counter to each other, while the omni wheels serve as support. The driven wheels can be arranged on an axle and an omni wheel is located in front of and behind this axle, in particular on the central vertical of the connection between the two driven wheels.

According to one embodiment of the storage system, a carrier plate level is formed by carrier plates above at least one robot level. The carrier plates are spaced apart along the projection of the central axes of the substantially rectangular baseplates onto the carrier plate level perpendicular to the robot level. The container carriers rest on the carrier plates and can be moved in the carrier plate level. Robots couple to the container carriers, wherein the coupling reaches through the distance between the carrier plates. The coupling allows robots to move the container carriers without lifting the load of the container carriers.

According to one embodiment, the storage system comprises balconies for removing or storing goods, containers, container carriers and/or robots. Balconies can be realized by having a baseplate, in particular a modified one, protruding and not covered at the top. Alternatively, by the recess around a baseplate from one robot level to the next, it is also possible to access goods, containers, container carriers or robots from above.

At such a balcony or recess, goods can be removed or stored by humans or machines, e.g., picking robots. If such balconies or recesses are next to each other or in the vicinity on different robot levels, goods, containers, container carriers and/or robots can be moved from one robot level to another manually or, for example, by a picking robot that removes goods or a container on one level and places it on another level. This eliminates the need for devices with which the robots moving on the robot levels can transfer goods, containers and/or container carriers between levels. By using the existing infrastructure, e.g., an existing picking robot, it is also possible to dispense with additional lifting mechanisms for the vertical plane.

As an alternative or in addition to removal and storage from and on balconies or recesses, the removal and storage of goods, containers, container carriers and/or robots can also be carried out in an equivalent manner in a horizontal direction on the storage system.

Furthermore, a method for setting up a modular storage system is proposed.

According to one embodiment of the method for constructing a modular storage system, an inherently stable structure is created by connecting vertical supports, in particular vertical supports consisting of several pillars, to baseplates, in particular by screwing angle profiles to the vertical supports and the baseplates. The structure can support robots, container carriers, containers and goods and can take up the loads caused by accelerations of the robots and movement of the container carriers, containers and goods without using cross struts between the vertical carriers.

A method for operating a modular storage system is also proposed.

According to one embodiment of the method for operating a modular storage system, one or more robots move along lines on baseplates in the storage system and move container carriers in the storage system.

The embodiments and features described for the proposed device apply accordingly to the proposed method.

Other possible implementations of the invention also include combinations of features or embodiments described above or below with regard to the exemplary embodiments that are not explicitly mentioned. A person skilled in the art will also add individual aspects as improvements or additions to the respective basic form of the invention.

Further advantageous embodiments and aspects of the invention are the subject of the dependent claims and of the exemplary embodiments of the invention described below. In the following, the invention is explained in greater detail by means of preferred embodiments with reference to the appended figures.

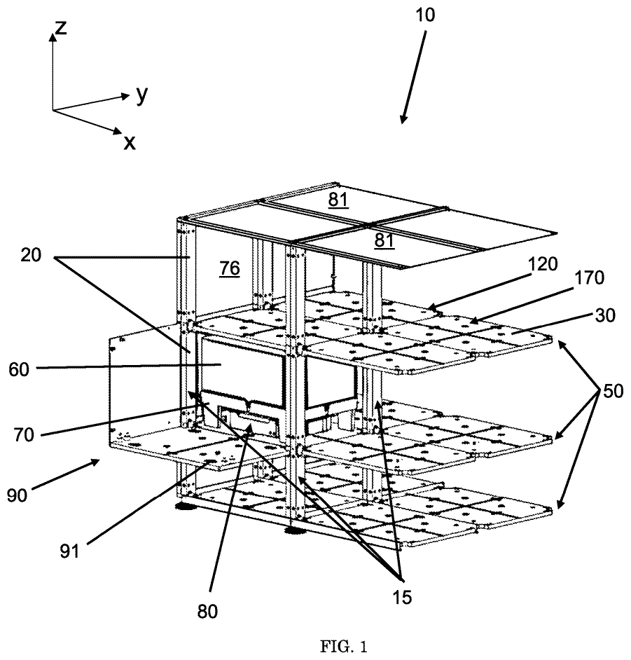

FIG. 1 shows a detail of a bearing system for a lifting concept;

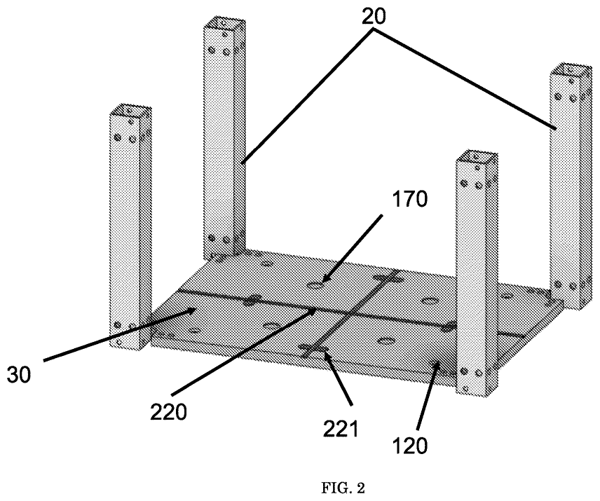

FIG. 2 shows baseplates with pillars;

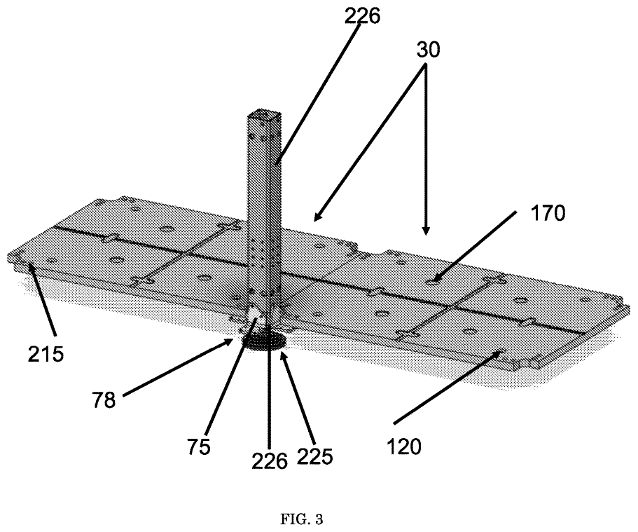

FIG. 3 shows details of the attachment of a pillar to a foot piece and a baseplate with an angle profile;

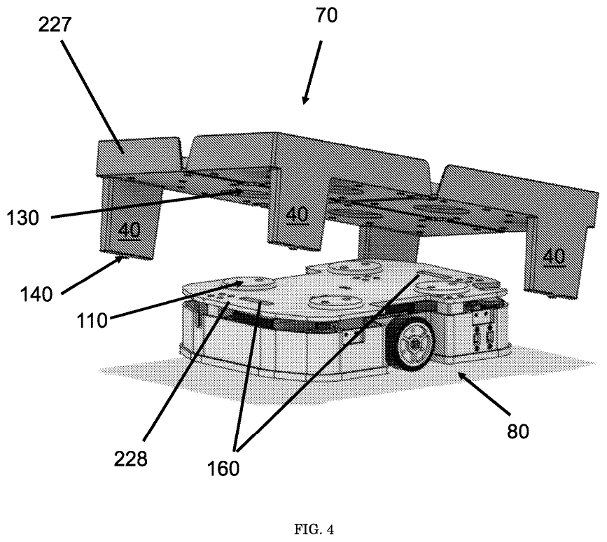

FIG. 4 shows a container carrier with a robot for a lifting concept;

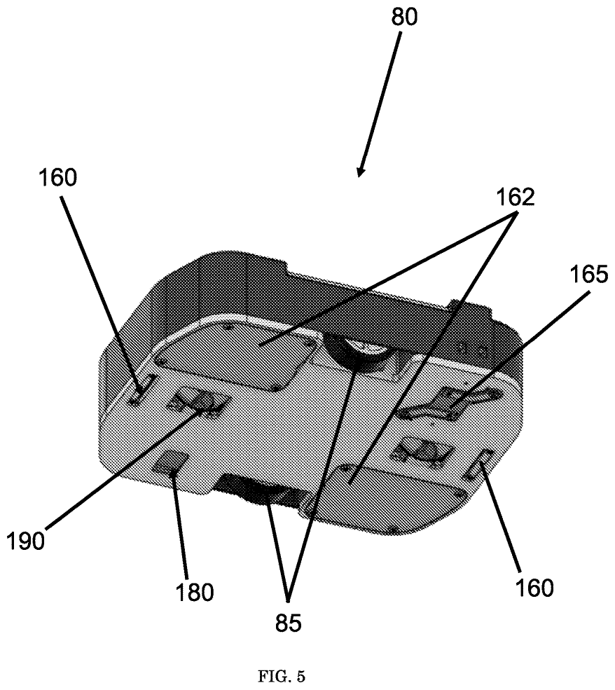

FIG. 5 shows details of the underside of a robot;

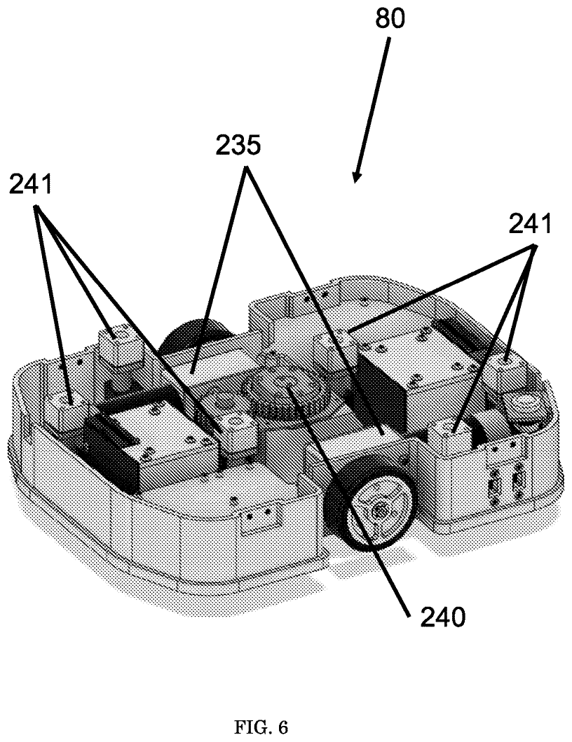

FIG. 6 shows details of a robot for a lifting concept;

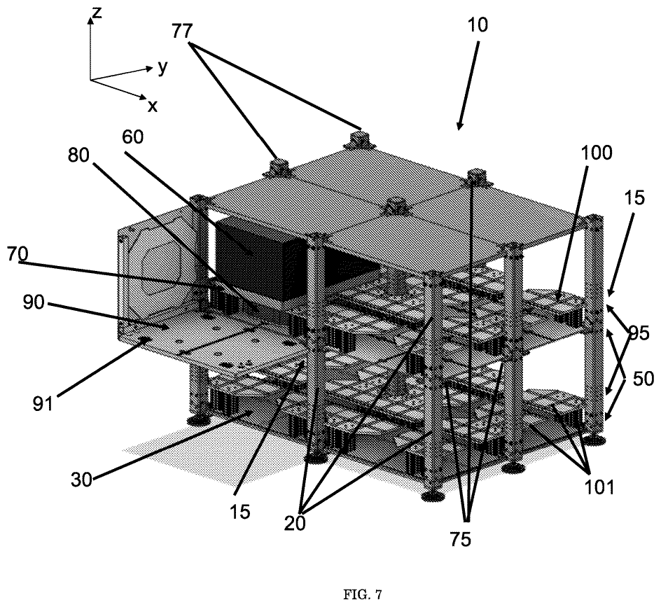

FIG. 7 shows a detail of a storage system for a carrier plate concept;

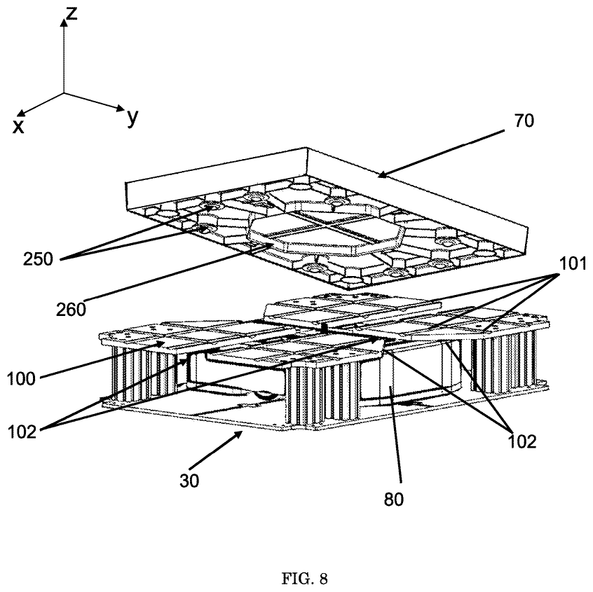

FIG. 8 shows a container carrier above carrier plates with a robot for a carrier plate concept.

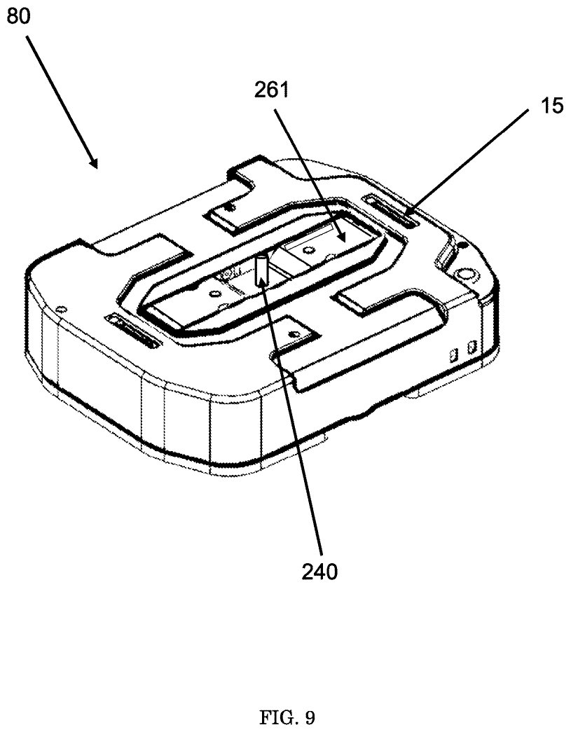

FIG. 9 shows the top side of a robot for a carrier plate concept;

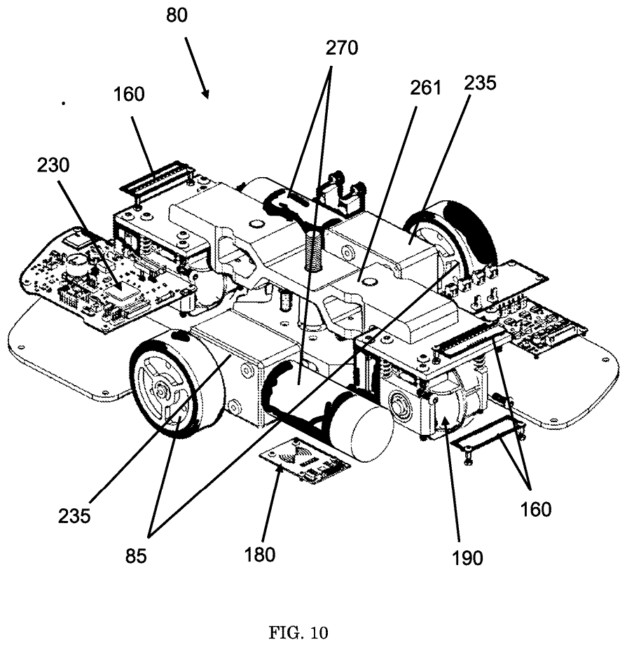

FIG. 10 shows details of a robot for a carrier plate concept;

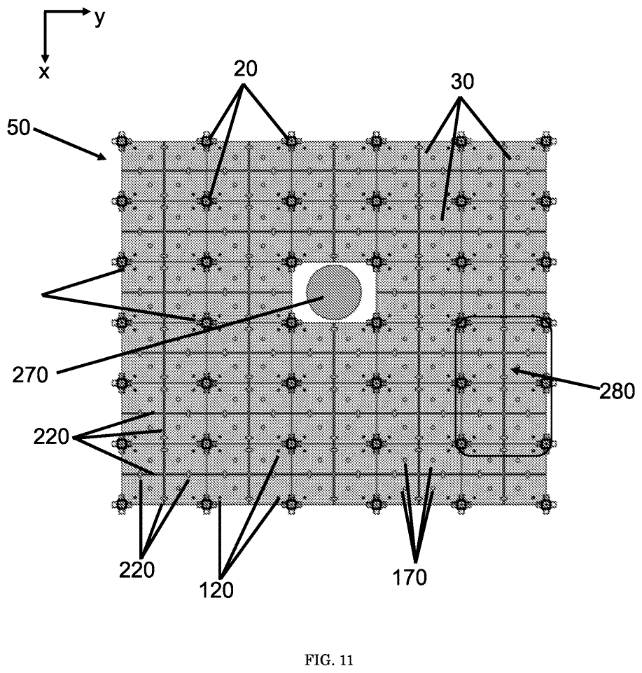

FIG. 11 shows, from above, a robot level of a storage system adapted to a column.

In the figures, identical or functionally identical elements have been given the same reference signs, unless otherwise stated.

FIG. 1 shows a detail of a storage system 10 with three robot levels 50, wherein the distance in the z direction between the lower level and the middle level is 400 mm, which is less than the distance between the middle level and the upper level, which is 600 mm. The robot levels 50 lie in the x-y plane and are aligned horizontally.

In FIG. 1, four baseplates 30 are shown in each robot level 50 inside the storage system 10. The robot levels 50 extend further in the x and y directions than shown in the detail, e.g., a robot level 50 can have 15 baseplates 30 in the x direction and 20 baseplates 30 in the y direction.

The baseplates 30 inside the storage system 10 are rectangular, with recesses in the region of the pillars 20. The baseplates 30 are approximately 700 mm×500 mm in size and approximately 20 mm thick. With this size of baseplate 30, a container support 70 with a size of 650 mm×450 mm can be positioned on each baseplate 30. The container carrier 70 can in turn carry a small load carrier with the standard dimensions of 600 mm×400 mm base area as container 60. Thanks to the standardized system of small load carriers, a container carrier 70 can also accommodate other combinations of small load carriers, e.g., two containers 60 with a base area of 300 mm×200 mm and one container 60 with a base area of 400 mm×300 mm. The use of the system of standardized small load carriers offers advantages in the loading of the storage system 10, as the goods can be placed in standard containers. In addition, a container 60 in which goods are stored can help with defective packaging of the goods. For example, the packaging of the goods, the container 60 in which the goods are stored and the container carrier 70 can be used to achieve multiple levels of security, e.g., against the leakage of liquids, so that these do not contaminate the storage system 10. The direct storage of parcels or boxes on the container carrier 70 without repacking in small load carriers, or combined loading is also possible.

Coated MDF boards are used as baseplates 30. Wood-based materials as baseplates 30 are advantageous for sound insulation or sound reduction when the robots 80 move in the storage system. Various wood-based materials provide sufficient stability so that additional horizontal bracing of the storage system 10 is not necessary for fastening via the baseplates 30. The baseplates 30 are designed for loads of around 60 kg per plate. The baseplates 30 abut each other or have a small gap of less than 1 mm to 2 mm so that the robots 80 can easily pass over the gaps. For this purpose, the recesses are dimensioned in such a way that they can accommodate the pillars 20 at the corners of the baseplates 30. The recess in the baseplates of FIG. 1 is a square with a side length of approx. 40 mm at each corner of the baseplate 30.

A baseplate 30 is attached to each of four pillars 20. This can be achieved with angle profiles 75, which are not shown in FIG. 1. The angle profiles 75 connect two pillars 20 to each other in the vertical z direction and provide a support surface for the baseplates 30. The connected pillars 20 form a vertical support 15. If modularity in the z direction is dispensed with, a vertical support 15 can also be designed in one piece and angle profiles 75 are attached at different heights of the vertical support 15.

The pillars 20 are substantially square hollow profiles made of steel with a material thickness of 3 to 4 mm. In the embodiment shown in FIG. 1, the pillars 20 are inserted at two heights in the z direction of 400 mm and 600 mm, so that two different level spacings can be realized in the storage system 10. Two different heights of the pillars 20 allow increased flexibility in the use of space by enabling a lower level height for lower or smaller goods and still keeps the number of variants of the components of the modular storage system 10 low. However, the baseplates 30 of a robot level 50 are always mounted at the same height, so that a robot 80 can move unhindered over the robot level 50.

All pillars 20 of a robot level 50 have the same shape and are provided with holes with threads or threaded inlays for fastening the angle profiles 75 and the outer panels 76. The pillars 20 of all levels have the same cross-sectional shape. The angle profiles 75 are fastened to each side of the pillar 20 inside the storage system 10 in such a way that a lower and an upper pillar 20 are fastened to each other and a baseplate 30 is screwed to two angle profiles 75 at a recess in each case.

An end piece 77 can be attached to the top of the pillars 20, which are connected to each other in the z direction, and a foot piece 78 is attached to the bottom. The foot piece 78 can also compensate for height differences in the floor. The foot piece 78 can be fastened with the same angle profiles that also connect the pillars 20 to each other and to the baseplates 30.

The foot pieces 78 also serve to decouple sound from the floor. The storage system 10 is simply placed on the floor and is not screwed or fixedly connected. The weight of the bearing system 1 provides sufficient stability. Vibration isolators can be inserted into the foot pieces 78, e.g., damping elements, which reduce the transmission of structure-borne noise, e.g., from the movement of robots 80, into the floor and thus into the building.

Sheet metal, plastic panels, wood or wood-based panels can be attached to the outer sides and top of the storage system 10 as outer panels 76 or cover panels 81, which prevent interference with the storage system 10. The outer panels 76 are screwed directly to the pillars 20, the cover panels 81 can be attached to end pieces of the pillars 20 or, similar to the baseplates 30, with the aid of angle profiles. Outer panels 76 and/or cover panels 81 can also be designed to be sound-absorbing, e.g., provided with rock or glass wool layers, with sound-absorbing layers of foams or also with multi-layer structures for sound absorption.

In FIG. 1, a container carrier 70 with a container 60 and a robot 80 under the container carrier 70 is shown on one of the baseplates 30 in the storage system 10. In the configuration of FIG. 1, the maximum number of container carriers 70 in a robot level 50 is the number of baseplates 30 minus one, so that at least one baseplate 30 is always free for maneuvering. Several robots 80, e.g., three robots 80, can move on one robot level 50.

The baseplates 30 have a pattern applied to or embedded in them to support the navigation of the robots. In addition, the baseplates 30 have passive RFID transponders 170 for the absolute orientation of the robots 80 on a robot level 50. Furthermore, the baseplates 30 have positioning elements 120 to support the exact positioning of the container carriers 70. Additional elements such as earthing strips to reduce static charges can also be incorporated into the baseplates 30. RFID transponders 170, positioning elements 120, patterns and, if necessary, earthing strips are incorporated or attached to the baseplates 30 in such a way that the baseplates can be prefabricated and each prefabricated baseplate 30 can be installed at any position during assembly of the storage system 10. The baseplates 30 have pre-drilled holes 215 for screwing to the angle profiles for fastening to the pillars 20.

FIG. 1 shows a balcony 90, which is only shown clad on one side for better visibility. As a rule, such a balcony 90 will be clad on three sides, so that removal from or storage in the balcony takes place upwards. However, the balcony 90 can also, for example, only be partially covered in the opposite direction to the y direction, so that removal or storage is possible towards the front, opposite the y direction. A baseplate 30, which may be modified, serves as the basis for the balcony 90 and is attached to the pillars 20 with the same angle profiles as the baseplates 30 inside the storage system 10. The balcony 90 is designed to be open at the top so that goods, containers 60, container carriers 70 or robots 80 can be removed or stored upwards or from above. Removal or storage can be carried out by picking robots or by persons. In the case of removal by persons, loads in a container 60 or the mass of a robot 80 must be kept in a range of less than 20 kg, preferably less than 15 kg, so that multiple removal or storage by one person is ergonomically possible.

Modifications of the baseplate 30 of the balcony 90 can be, for example, weighing units 91 with which the weight of a container carrier 70 with the containers 60 resting on it and, in particular, the goods located in the containers can be determined. The weighing units 91 in the balcony 90 are provided in the modified baseplate 30 of the balcony 90 at the position of the positioning elements 120 of the unmodified baseplates 30 of the storage system 10. A weighing unit can be used to check the plausibility of removals or storage and also to check that the load is correct. Alternatively or additionally, the weighing unit can also be installed in each robot 80.

The movement in the region of the balcony 90 can be reduced to below 300 mm/s by controlling the robots 80. Such a speed limitation can be realized, for example, by an induction sensor in the robot and a corresponding metal plate on the outside of the corresponding baseplate. An intervention by a person or a picking robot in the balcony 90 can also be detected or secured with the aid of light barriers or cameras or rolling gates or grilles.

Cameras and barcode scanners can also be arranged on balcony 90. This can be used to confirm storage and removal as well as for monitoring and theft protection.

A robot level 50 has at least one balcony 90, which can then be used to load the storage system 10 and remove items from the storage system 10. However, a robot level 50 can also have several balconies 90, e.g., two balconies 90, wherein one of these is used for loading and the other for unloading. Since the balconies 90 can be positioned flexibly in the edge region of the storage system 10, the balconies 90 can be arranged in such a way that efficient guidance of the material flow to the picker is possible and the picker of the goods does not have to move through a racking system.

Goods or containers 60 can be transferred between two robot levels 50 by removing them from a first balcony 90 in a first robot level 50 and inserting them via a second balcony 90 of a second robot level 50. In this way, the robots 50 inside the storage system 10 do not require any mechanisms to move containers 60, container carriers 70 or goods between two robot levels. It is also possible to dispense with a lifting system for robots 50, containers 60, container carriers 70 or goods between the levels in addition to the existing removal systems.

The components constituted by baseplates 30, pillars 20, angle profiles 75 or alternative fasteners of the baseplates 30 to the pillars 20 form a fixed structure and do not require any moving parts during operation. This construction is supplemented by foot pieces 78, outer panels 76 and cover panels 81 as well as balconies 90, which also do not require any moving parts during operation. The robots 80 then move in this structure, which in turn move the container carriers 70, possibly with the containers 60 and the goods. The basic structure for such a storage system 10, which is modular in all three spatial directions x, y and z, can therefore be constructed with just three components: baseplate 30, pillar 20 and angle profile 75. In the outer regions of the storage system 10, foot pieces 78 and end caps for the pillars 20, two differently sized outer panels 76 and cover panels 81 are also useful-just another five components. Balconies 90 can also be realized with these elements, possibly with a special baseplate 30. The storage system is equipped with container carriers 70 and robots 80.

Containers 60 can then be inserted during operation. Robots 80, container carriers 70 and containers 60 can also be removed or inserted during operation. Such a storage system 10 can be realized with a limited number of necessary components after measuring the installation site and without lengthy project planning. The system can be extended and also dismantled and flexibly adapted to a different location. The individual components of the bearing system 10 can be fastened together with one or two types of screw. Both screws preferably have the same screw drive so that the bearing system 10 can be assembled with a minimum of tools.

FIG. 2 shows a more detailed image of a baseplate 30 between four pillars 20. The baseplate 30 has lines 220 along the longitudinal and transverse axes. The robot 80 can follow these lines 220 with the aid of a sensor, e.g., an IR line array, and thus maneuver from one baseplate 30 to the next baseplate 30 and follow a path in the x or y direction.

In addition to the lines 220, short transverse markings 221 are provided on the lines 220, with the aid of which the robot 80 can center itself on a baseplate 30. The transverse markings 221 can also be used as markings for a deceleration process or an acceleration process, for example so that the robot 80 reduces its speed in good time when positioning itself on a baseplate 30 in order to stop at the correct position. Alternatively, the transverse markings 221 can also be designed as circles or segments of circles on the baseplate 30. The baseplate has four passive RFID transponders, RFID tags 170. Using the RFID tags 170, the absolute position of the robot 80 in the storage system and its orientation can be determined with only one RFID reader 180 per robot 80. So that the baseplates 30 can be laid chaotically, the RFID tags 170 of the baseplates 30 are measured and mapped after or during the assembly of the storage system 10. The lines 220 can be painted on the baseplates 30. Alternatively, the lines 220 may be glued to the baseplates 30 or created by modifying the surface of the baseplates 30, for example by roughening or milling.

Accurate and defined positioning of the container carrier 70 on the baseplate 30 can be mechanically assisted by indentations 120 at four points on the baseplate, into which corresponding complementary protrusions 140 on the feet 40 of the container carrier 70 slide when approximately positioned. With conical domes on each of the four feet 40 of the container carrier with complementary indentation 120 in the baseplates, the process speed can thus also be increased, since navigation must be somewhat less precise and yet exact positioning can be achieved. Alternatively, magnets and metal parts in the baseplates 30 and container carriers 70 can also be used for precise and defined positioning of the container carrier 70.

Alternatively, embodiments of the invention in which multiple robots 50 move simultaneously on a baseplate are also possible. To this end, the pattern of lines 220, transverse markings 221, RFID tags and/or indentations may be multiplied on a plate, for example two or four of the crosses of lines 220 with the other elements as shown in FIG. 2 could be located on a baseplate 30.

FIG. 3 shows in detail the attachment of two baseplates 30 to a pillar 20 and a foot piece 78. The foot piece 78 comprises a foot end piece 226, the cross section of which corresponds approximately to the cross section of the pillar 20, and an installation part 225 that can be adjusted in the z direction. The foot end piece 226 can be a plate or a plate attached to a hollow profile. The installation part 225 can be designed to dampen vibrations, for example by means of an elastic coating or buffer on a metal part. The installation part 225 can be adjusted in the z direction by screwing it into a thread on the base end piece 226. By screwing it in at different depths, secured by a lock nut, height tolerances in the floor can be compensated for or the entire bearing system 10 can be aligned horizontally.

Four angle profiles 75, which are arranged on the four sides of the pillar 20 with a square cross section, fasten the foot piece 78 to the pillar 20 and to the foot piece 78 with one screw each. Two pillars 20 are also fastened to each other in a similar manner in the z direction to a vertical support 15. A baseplate 30 is screwed to a corner or to the recess in the corner with two angle profiles 75 each, wherein two screws each connect the baseplate 30 to an angle profile 75 at pre-drilled holes 215.

FIG. 4 shows the interaction between the container carrier 70 and the robot 80 in a configuration in which the robot 80 lifts the container carrier and any containers 60 and goods on it—lifting concept. For better recognizability, the container carrier 70 is shown floating in FIG. 4. The container carrier 70 is designed as an independently standing platform, which can be driven under and lifted by the robot 80. The use of a container carrier 70 makes it possible to use one or more containers 60 of different sizes on one container carrier 70. The use of only one container carrier 70 with a corresponding design makes it possible to reliably pick up the container 60 by the robot 80, since the robot 80 always docks onto the same interface on the container carrier 70. Container carriers 70 can be easily replaced when worn or removed for cleaning without changing the module structure.

In order for the container carrier 70 to be picked up by the robot 80 in a defined manner and thus to be set down at the desired position with pinpoint accuracy and to be secured against horizontal displacement or twisting due to accelerations of the robot 80 when moving through the storage system 10, the robot 80 couples into four round frustoconical complementary container carrier recesses 130 on the underside of the container carrier 70 with the aid of four frustoconical domes 110 on the lifting plate 228 of the robot 80. Alternatively, there may also be three recesses 130 or a cone and an anti-rotation lock or a cone with an anti-rotation lock. The coupling of the robot 80 to the container carrier is intended to create a positive fit by means of corresponding shapes on the lifting plate 228 and container carrier 70, which prevents the container carrier 70 from twisting or shifting relative to the robot 80 in the raised state.

The container carrier 70 has a similar line pattern on its underside as the baseplates 30. This line pattern can be used to check the correct positioning of the robot 80 under the container carrier 70 by means of the sensors 160 arranged at the top of the robot. This is particularly important if, due to an error, e.g., a power failure or a robot defect, a container carrier 70 is not exactly at a defined position on a baseplate 30. In this case, the position is detected by IR line arrays as sensors 160. The IR line arrays 160 can be self-attached to the lifting plate 228 or act through recesses in the lifting plate 228. Additionally or alternatively, container carriers 70 can also be equipped with RFID tags and the robots 80 with a further RFID reader, e.g., on the top side.

The container carriers 70 are designed to be stackable for transportation or storage, i.e. the feet 40 are shaped so that they fit inside the edge 50 of the support surface of the container carrier 70. Alternatively, the feet 40 can be designed to be removable. The overall shape of the container carriers 70 can be designed to be stackable inside one another, wherein the feet 40 of one container carrier 70 can be inserted from above into the feet 40 of another container carrier 70. By stacking, removing the feet 40 or stacking one inside the other, the packing density or stability for transportation or storage of the container carriers 70 can be increased.

The lifting plate 228 of the robot 80 is equipped with a ball screw 240 in the event of a fault, so that the lifting plate 228 lowers in the de-energized state. If an error occurs in the robot 80, the container carrier 70 is released. The robot 80 can be pushed out from under the container carrier 70 by another robot 80.

Container carrier 70 and robot are dimensioned so that the robot 80 can rotate under the container carrier 70 and thus change the direction of movement in the storage system 10. The coupling between the container carrier 70 and the robot 80 is ensured with a rotation of 90° in each case.

The robot 80 has an overall height of only around 100 mm. The flat design optimizes the space utilization of the storage system 10.

FIG. 5 shows the underside of the robot 80. The robot 80 is driven by two separately controllable wheels 85. The direction of travel of the robot is determined by a differential drive of the wheels 85. If the wheels 85 are operated in opposite directions, the robot 80 rotates on the spot. Two omni wheels 190, also known as omnidirectional wheels, support the robot 80 during its movement and enable both forward movement and rotation. The removable batteries can be removed from the underside. For this purpose, the batteries can be accommodated, for example, behind removable battery flaps 162 in the robot 80. Alternatively, the batteries can also be screwed or latched directly to the robots 80. Batteries, e.g., aging batteries, can thus be easily replaced on site or batteries with a higher capacity can be used. The easy removal of the batteries means that the robots can also be shipped without batteries, e.g., for inspections or repairs. This saves weight during shipping and avoids special shipping regulations for the shipment of Li-ion batteries. The battery capacity of the Li-ion batteries used is sufficient for about 8 h of operation of the robot in the storage system 10. When the battery level is low, the robot 80 navigates to the charging station. The coupling point 165 with the charging station is also shown in FIG. 5 on the underside of the robot. Alternatively, coupling points can also be located on the front or rear of the robot, preferably in the direction of travel. Alternatively, the robot 80 and the storage system 10 can also be equipped with a device for inductive charging. Li-ion batteries have advantages in terms of installation space and capacity, but supercapacitors can also be used for certain embodiments.

The IR line arrays 160 are used for navigation in conjunction with the lines on the baseplates 30.

An RFID reader 180 is used in conjunction with the RFID tags 170 on the baseplates 30 to determine the absolute position and orientation of the robot 80 in the storage system 10. In one embodiment, in which each baseplate 30 has four RFID tags 170 and the RFID tags are mapped, the baseplate 30 on which the robot 80 is standing and also the direction in which the robot 80 is located on the baseplate 30 is known by reading the RFID tag 170 by the RFID reader 180 located above it. Alternatively, several, in particular four, RFID readers 180 can be attached to the robot and only one RFID tag on a baseplate.

Due to the redundancy of the sensor system, in FIG. 5 two IR line arrays 160 and an RFID reader 180 on the underside of the robot 80, it is often possible to maneuver the robot 80 to a removal point, e.g., a balcony 90, from the storage system 10 if a sensor fails.

FIG. 6 shows the robot 80 for the lifting system in detail from above. Stepper motors have been omitted in order to reduce the overall height and power consumption. Brushless DC motors with incremental encoders provide the propulsion and maneuvering of the robot 80.

The line guidance on the baseplates 30 in conjunction with the sensors 160, the IR line arrays and the robots 80 compensate for the lower precision of these motors. The wheels 85 are driven by a worm gear 235.

A ball screw 240 enables the lifting plate 228 to be lifted. Tilting of the lifting plate 228 can be avoided by at least one linear guide 241. Further details of the robot 80 are also shown in the similarly designed robot 80 of the carrier concept in FIG. 10.

FIG. 7 shows a carrier plate system of the storage system 10 as an alternative embodiment to the lifting system shown in FIGS. 1 to 6. In the lifting system, robots 80 lift appliance carriers 70 in order to transport them. In the carrier plate system shown in FIG. 7, robots 80 reach into the container carriers 70 from below and move them without lifting them. For this purpose, the container carriers 70 are equipped with rollers with which they can be moved on carrier plates 100. The carrier plates 100 are provided with grooves 101 to guide the movement. Alternatively, the carrier plates 100 could also be provided with rollers 250 and the container carriers 70 with grooves 101. Combinations of rollers 250 on the carrier plates 100 and on the container carriers 70 are also possible.

The basic structure of the support plate system shown in FIG. 7 is very similar to the structure of the lifting system shown in FIGS. 1 to 6 and a person skilled in the art can also use or implement the features shown in the lifting system in a suitable manner in the support plate system and vice versa. Pillars 20, baseplates 30 and angle profiles 75 interact in the same way in the lifting and support plate system. Outer panels 76 and cover panels 81 can be fitted to both systems, as can balconies 90, foot pieces 78 and end pieces 77. The same small load carriers can also be used in the lifting and carrier plate systems.

The main differences between the lifting system and the carrier plate system lie in the interaction between the robots 80 and the container carriers 70, in the container carriers 70 and in the carrier plates 100, which in the carrier plate system are also present in the storage system 10 and form a carrier plate level 95. Above the robot levels 50, at approximately the same distance as the height of the feet 40 of the container carriers 70 of the lifting system, carrier plates 100 are fitted in the carrier plate system. The support plates 100 can be attached to the baseplates 30 or to the pillars 20 or to both. The task of the carrier plates 100 is to support the weight of the container carriers 70, the containers 60 and the goods on the container carrier 70 or in the containers 60. The carrier plates 100 are made of metal in order to be able to take the loads. Alternatively, however, the carrier plates 100 can also be made of other materials, for example wood-based materials, composite materials, plastic or plastic with metal inlays. By selecting suitable materials, the generation of sound can be reduced. The carrier plates 100 are mounted in such a way that there is a free space between the carrier plates 100 above the central axes of the baseplates 30 in the longitudinal and transverse directions. Robots 80, which, as in the lifting system, move on the baseplates 30 along lines 220 on their central axes, can engage the underside of a container carrier 70 through the free space between the carrier plates 100 and move the container carrier 70. At the intersections of the lines 220, i.e. at the center of the baseplates 30, the robot 80 can change direction by 90° to the right or left. In each case, four carrier plates 100 are mounted above a baseplate 30. Alternatively, four support plates 100 surrounding a pillar 20 could also be designed in one piece. Alternatively, a multiple of the support plate configuration in FIG. 7 could also be attached to a baseplate 30. Support plates 100 on adjacent baseplates 30 abut each other or are spaced apart with a small gap. In order to compensate for tolerances at the transition from one baseplate 30 to an adjacent baseplate 30, the support plates 100 have lead-in chamfers 102. At the edges of the carrier plates 100 and in particular in the area where the grooves 101 meet the edge of the carrier plates 100, the carrier plates 100 can have a chamfer, not shown in FIG. 7, so that the movement of a container carrier 70 from one carrier plate 100 to the other is facilitated.

The grooves 101 of the carrier plates can be designed in such a way that a container carrier, which is located approximately centered above a baseplate 30, e.g., only 1 to 2 cm off-center, is brought into a centered position by a longitudinal profile, e.g., increasing and decreasing indentations along the grooves. Alternatively, such automatic centering above the baseplate can also be achieved using magnets.

In FIG. 7, the support plates 100 in the area of the balcony 90 are not shown for better visibility.

End pieces 77 are shown on some of the pillars 20, which are connected to the pillars 20 and the cover panels 81 by means of angle profiles 75. The pillars 20 are also connected to each other with the angle profiles 75 and the baseplates 30 are connected to the pillars 20.

FIG. 8 shows a detailed view of the interaction of container carrier 70, carrier plates 100, robot 80 and baseplate 30 for a carrier system. The four carrier plates 100 are connected to a baseplate 30. A robot 80 is located on the baseplate 30. For better visibility, the container carrier 70 is shown removed so that the underside of the container carrier 70 can be seen resting on the carrier plates 100 during operation. Rollers 250 are located on the underside of the container carrier 70. These rollers are designed as ball rollers. The container carrier has eight rollers 250. The rollers 250 run in grooves 101 on the carrier plates 100. The rollers 250 are offset in pairs in both the x and y directions so that at least one of the pairs of rollers rests on the carrier plates 100 when passing over the gap 102 between the carrier plates 100.

An engagement region 260 is provided on the underside of the container carrier 70. The robot 80 can engage in the engagement area with a suitably shaped gripper 261, shown in FIG. 8, without lifting the container carrier 70. If the robot 80 and the container carrier 70 are coupled in this way, the robot 80 can move the container carrier 70 on the carrier plates 100. As an alternative to engaging, the coupling could also be realized magnetically, for example by switching on an electromagnet.

FIG. 9 shows the upper side of a robot 80 of the carrier plate system. In contrast to the lifting plate 228 of the robot 80 of the lifting system, the robot 80 of the carrier plate system has a gripper 261. This gripper can be lifted with a ball screw 240. In the event of an error, e.g., if the robot 80 is de-energized or is set to an error mode by the software, the gripper 261 automatically lowers so that the robot 80 releases the container carrier 70 again. The robot 80 of the carrier plate system also has IR line arrays 160 on its upper side, which enable precise positioning relative to a container carrier 70 using a pattern on the underside of the container carrier 70.

In the areas in which it first comes into contact with the container carrier 70 during its upward movement, the gripper 261 is provided with chamfers, bevels or conical elements in such a way that when the robot 80 and the container carrier 70 are in a slightly offset position relative to one another, the container carrier 70 is automatically displaced by the lifting of the gripper 70 and coupling of the robot 80 to the container carrier 70 is made possible.

FIG. 10 shows schematic details of the interior of the robot 80. A robot 80 of the carrier plate system is shown, wherein it is substantially distinguished by the gripper 261 instead of the lifting plate 228. To make the details easier to recognize, the housing of the robot 80 is hidden in FIG. 10. Brushless DC motors 270 with incremental encoders ensure the propulsion and maneuvering of the robot 80 via the wheels 85. The wheels 85 are driven via worm gears 235. This enables a flat design of the robot 80 for optimized space utilization by the storage system 10. IR line arrays 160 are used for positioning to lines and patterns on the baseplates 30 or the underside of the container carriers 70. The absolute position and orientation of the robot 80 in the storage system 10 can be determined using the RFID reader 180 and RFID tags 170 on or in the baseplates 30. Omni wheels 190 are used to support the robot 80, which also allow the robot 80 to rotate around its own axis by rotating the wheels 85 in the opposite direction.

The robot 80 comprises a computer chip 230 or a control board. There are different concepts for controlling the storage system 10, such as how this is carried out on a server, in particular connected to a cloud, and on the robot 80 itself.

According to one embodiment, a server is present in close proximity, in particular in the same building or room, as the robot levels 50 and robots 80. The server communicates wirelessly with the robots 80 via standard protocols such as WI-FI, Bluetooth, Zigbee, Z-Wave or 6LowPAN.

According to one embodiment, the server processes data about the goods, positions of container carriers 70, containers 60, goods and robots 80 in the storage system 10. Software is operated on the server which manages the storage process. For example, the server receives a request for specific goods. Commands are then sent from the server to a robot 80 to bring a specific container carrier 70 on a robot level 50 to a removal point, e.g., a balcony. For this purpose, the server transmits to the robot 80 the path to the container carrier 70 from the position of the robot 80. The software of the robot, which runs on the processor 230, is able to follow this path independently, e.g., to follow a line 220 with the aid of the IR line arrays 160 and to turn at an intersection of lines 220 in accordance with the transmitted path. How much control power is provided by the robot 80 and how much control power is provided by the server can be determined on an application-specific basis. The server in turn is integrated into a cloud via which, for example, requests for goods, but also firmware updates for the robots 80 or updates for the software for controlling the warehouse can be imported by the server.

In the space of the robot levels 50 and robot 80, in particular in the vicinity of the removal and storage points, e.g., the balconies 90, there is a display which provides operators with information about the storage system 10, its status or current processes, and an operating unit with which, for example, storage or removal can be confirmed.

The server can also control one or more picking robots that store or remove goods and/or containers in the storage system 10.

In one embodiment of the invention, a robot 80 may also be or be converted to a cleaning robot and be or be provided with suction and/or mopping units to clean the storage system 10 at regular or irregular intervals.

FIG. 11 shows a view from above of a robot level 50 of baseplates 30 of a storage system 10. The robot level 50 is formed by six baseplates 30 in the x direction, five baseplates 30 in the y direction. Inside the robot level 50, one baseplate 30 is omitted. This allows the robot level 50 to enclose a column 270 of a building structure in which the storage system 10 is installed. A larger column 270 could be built around by omitting further baseplates 30. The storage system 10 can be adapted to other floor plans accordingly. It can also be adapted in the z direction, e.g., to pipes running along the ceiling or to sloping roofs.

When configuring the storage system 10, care must be taken to ensure that there are unobstructed travel paths for the robots 80 in a robot level 50.

Lines 220 run through the robot level 50, which are applied to various baseplates 30 and continue on neighboring baseplates 30. The baseplates substantially form a closed robot level 50. Neighboring baseplates 30 abut each other or the distances between neighboring baseplates 30 are so small, e.g., 2 mm, that robots 80 can travel over the boundaries of neighboring baseplates 30. With small distances, the noise development is reduced and the vibration of the container carriers 70 and the containers 60 on the robots is also reduced. Transverse markings 221 on the baseplates facilitate the centering of robots on a baseplate 30 and thus also the alignment relative to container carriers 70. FIG. 11 shows the lifting system, in which indentations 120 facilitate the exact positioning of the container carriers on a baseplate 30. Also shown are RFID tags 170 for determining the absolute position and direction of the robots 80 in the robot level 50.

The baseplates 30 are screwed to the pillars 20 at holes 215 via angle profiles 75 not shown in FIG. 11. A pillar 20, which is surrounded by four baseplates 30, is connected to each baseplate at two angle profiles 75 with two screws each.

FIG. 11 shows how several baseplates 30 can be combined in one piece in an alternative embodiment. For example, the surface 280 formed by two baseplates 30 with two lines 220 in the y direction, eight RFID tags 170, eight transverse markings 221 can represent a one-piece plate. Two robots 50 can be located simultaneously on this plate under two container carriers 70. The two pillars in the middle in the x direction could be omitted. Such a modification with several storage locations on one plate is still modular and can be constructed flexibly. However, the larger the panels become, the less adaptable they are to existing building structures and the more difficult it becomes to set up the storage system 10.

Although the present invention has been described with reference to exemplary embodiments, it can be modified in many ways.

LIST OF REFERENCE CHARACTERS

| | |
|---|---|
| storage system | 10 |
| vertical support | 15 |
| pillar | 20 |
| baseplate | 30 |
| feet | 40 |
| robot level | 50 |
| container | 60 |
| container carrier | 70 |
| angle profiles | 75 |
| outer panels | 76 |
| end piece | 77 |
| foot piece | 78 |
| robot | 80 |
| cover panels | 81 |
| wheels | 85 |
| balcony | 90 |
| weighing unit | 91 |
| carrier plate level | 95 |
| carrier plates | 100 |
| grooves | 101 |
| gap | 102 |
| dome | 110 |
| indentations | 120 |
| container carrier indentations | 130 |
| protrusions | 140 |
| IR line arrays | 160 |
| battery cover | 162 |
| charging contacts | 165 |
| RFID tags | 170 |
| RFID reader | 180 |
| omni wheels | 190 |
| positioning elements | 210 |
| holes | 215 |
| lines | 220 |
| transverse markings | 221 |
| installation part | 225 |
| foot end piece | 226 |
| edging | 227 |
| lifting plate | 228 |
| computer chip | 230 |
| worm gear | 235 |
| ball screw | 240 |
| linear guide | 241 |
| engagement region | 260 |
| gripper | 261 |
| motors | 270 |

1. A modular storage system having:
at least two horizontal robot levels, wherein the robot levels are each formed by at least three baseplates,
at least eight vertical supports, which are perpendicular to the robot levels and support the robot levels,
at least one robot on each robot level, which can move on the robot level,
at least two container carriers per robot level, which can be moved by the at least one robot on each robot level,
wherein the container carriers have feet for placing the container carriers on the baseplates, the height of which feet is greater than the height of the robots,
wherein the container carriers and the robots are shaped such that the robots can move under the container carriers and can rotate under the container carriers,
wherein the robots have a lifting device, with which the robots can lift a container carrier and displace it by moving the robots in the robot level.

2. The modular storage system as claimed in claim 1, wherein the storage system can be extended in the horizontal direction by adding further baseplates and further vertical supports.

3. The modular storage system as claimed in claim 1, wherein the vertical supports comprise a plurality of pillars connected to one another in a direction perpendicular to the robot levels and the height of the pillars corresponds to the distance between the robot levels, wherein the storage system can be extended in height by adding further pillars and inserting one or more further robot levels with baseplates.

4. The modular storage system as claimed in claim 3,
wherein in each case two pillars of a vertical support are each screwed together from all four sides with a respective angle profile
and four vertical supports are connected by a baseplate on each robot level, wherein the baseplates are screwed to angle profiles which are screwed to the four vertical supports.

5. The modular storage system as claimed in claim 1, wherein the baseplates comprise lines, in particular along central axes of the baseplates, for guiding the robots through the storage system and/or markings for positioning, in particular for centering, the robots on the baseplates.

6. The modular storage system as claimed in claim 5, wherein the robots have optical sensors, in particular IR line arrays, for recognizing the lines and/or markings, in particular wherein each robot has at least two optical sensors, in particular IR line arrays.

7. The modular storage system as claimed in claim 1, wherein the baseplates comprise RFID tags for determining the absolute position and orientation of the robots in the storage system, in particular wherein four RFID tags are mounted on a circle around the center of the baseplates, each offset by 90°.

8. The modular storage system as claimed in claim 1, wherein the robots comprise at least one omni wheel and/or a mecanum wheel.

9. The modular storage system as claimed in claim 8, wherein the robots have two driven wheels and two omni wheels.

10. A method for constructing a modular storage system as claimed in claim 1.

11. The method for constructing a modular storage system as claimed in claim 10, wherein by connecting vertical supports, in particular vertical supports consisting of several pillars, to the baseplates, in particular by screwing angle profiles to the vertical supports and the baseplates, an inherently stable structure is created which can support robots, container carriers, containers and goods and which can take up the loads caused by accelerations of the robots and movement of the container carriers, containers and goods without using cross struts between the vertical carriers.

12. A method for operating a modular storage system as claimed in claim 1.

13. The method for operating a modular storage system as claimed in claim 12, wherein one or more robots move along the lines in the storage system and displace container carriers in the storage system.
